(19) United States
(12) Patent Application Publication
(10) Pub. No.: US 2026/0036198 A1
(43) Pub. Date: Feb. 5, 2026

(54) MAGNET ASSEMBLY FOR A SELECTOR THAT INCLUDES OPPOSING FLUX CONCENTRATORS EXTENDING FROM A SINGLE MAGNET

(71) Applicant: GHSP, INC., Holland, MI (US)

(72) Inventors: William David Haynes, Norton Shores, MI (US); John Thomas Bagley, Grand Haven, MI (US); Brian William King, Grand Rapids, MI (US)

(73) Assignee: GHSP, INC., Holland, MI (US)

(21) Appl. No.: 19/259,429

(22) Filed: Jul. 3, 2025

Related U.S. Application Data
(60) Provisional application No. 63/677,452, filed on Jul. 31, 2024.

(51) Int. Cl. F16H 59/10; G01D 5/12

(52) U.S. Cl. CPC F16H 59/105; G01D 5/12

(57) ABSTRACT

A selector assembly includes a selector, a printed circuit board having a three-dimensional sensor for monitoring multi-directional movement of the selector, and a magnet assembly that is attached to the selector and in electromagnetic communication with the three-dimensional sensor. The magnet assembly includes first and second flux concentrators with a sensing area defined therebetween and a magnet generating a magnetic field. The magnet is engaged with the first and second flux concentrators to direct a linear flux path of the magnetic field through the sensing area. The three-dimensional sensor is positioned within the sensing area with the linear flux path extending therethrough. Movement of the selector moves the magnet assembly and the linear flux path relative to the three-dimensional sensor. Motion of the linear flux path relative to the three-dimensional sensor is communicated to a controller.

### CROSS-REFERENCE TO RELATED APPLICATIONS

This application claims priority to and the benefit under 35 U.S.C. § 119(e) of U.S. Provisional Patent Application No. 63/677,452, filed on Jul. 31, 2024, entitled MAGNET ASSEMBLY FOR A SELECTOR THAT INCLUDES OPPOSING FLUX CONCENTRATORS EXTENDING FROM A SINGLE MAGNET, the entire disclosure of which is hereby incorporated herein by reference.

### FIELD OF THE DISCLOSURE

The present disclosure generally relates to a selector interface, and more specifically, a selector interface that includes a magnet assembly for interacting with a three-dimensional sensor, where the magnet assembly includes a magnet and opposing flux concentrators.

### BACKGROUND OF THE DISCLOSURE

User interfaces for vehicles and other devices include selectors for operating various aspects of the device. These selectors can include sensor and magnet assemblies that are in electromagnetic communication with one another. These assemblies are used to deliver instructions to a controller or other aspect of the device.

### SUMMARY OF THE DISCLOSURE

According to one aspect of the present disclosure, a selector assembly includes a selector, a printed circuit board having a three-dimensional sensor for monitoring multi-directional movement of the selector, and a magnet assembly that is attached to the selector and in electromagnetic communication with the three-dimensional sensor. The magnet assembly includes a first flux concentrator positioned to a first side of the three-dimensional sensor, a second flux concentrator positioned to a second side of the three-dimensional sensor, and a magnet generating a magnetic field. The magnet is engaged with the first flux concentrator and the second flux concentrator. The magnetic field of the magnet is directed through the first flux concentrator and the second flux concentrator to create a sensor portion of the magnetic field. The sensor portion is defined by a linear flux path that extends between an output surface of the first flux concentrator and an input surface of the second flux concentrator. Further, the sensor portion of the magnetic field extends linearly through the three-dimensional sensor.

According to another aspect of the present disclosure, a selector assembly including a selector body operably disposed within a selector housing, a printed circuit board attached to the selector housing and having a sensor for monitoring multi-directional movement of the selector body, a magnet that is attached to the selector body, the magnet generating a magnetic field, and a flux concentrating assembly that is attached to the selector body and the magnet. The flux concentrating assembly is configured to define a sensor portion of the magnetic field. The sensor portion is defined by a linear flux path that extends between an output surface of the flux concentrating assembly and an input surface of the flux concentrating assembly. Further, the sensor is disposed between the output surface and the input surface and in electromagnetic communication with the sensor portion of the magnetic field.

According to yet another aspect of the present disclosure, a selector assembly includes a magnet that is attached to a selector body that is operable within a selector housing, first and second flux concentrators that direct a magnetic field of the magnet through a sensor portion of the magnetic field, and a three-dimensional sensor that is disposed within the sensor portion and is attached to the selector housing. Motion of the selector body moves the sensor portion of the magnetic field relative to the three-dimensional sensor. The three-dimensional sensor detects movement of the sensor portion and communicates the movement of the sensor portion to a controller.

According to another aspect, a selector assembly includes a selector, a printed circuit board having a three-dimensional sensor for monitoring multi-directional movement of the selector, and a magnet assembly that is attached to the selector and in electromagnetic communication with the three-dimensional sensor. The magnet assembly includes a first flux concentrator and a second flux concentrator, wherein a sensing area is defined therebetween, and a magnet generating a magnetic field. The magnet is engaged with the first flux concentrator and the second flux concentrator to direct a linear flux path of the magnetic field through the sensing area. The three-dimensional sensor is positioned within the sensing area with the linear flux path extending therethrough. Movement of the selector adjusts the relative position of the magnet assembly and the linear flux path with respect to the three-dimensional sensor. Further, motion of the linear flux path relative to the three-dimensional sensor is communicated to a controller.

According to another aspect, a selector assembly includes a selector body operably disposed within a selector housing, a printed circuit board attached to the selector housing and having a sensor, a magnet that is attached to the selector body and that generates a magnetic field, and a flux concentrating assembly that is attached to the selector body and the magnet. The flux concentrating assembly is configured to define a linear flux path of the magnetic field. The linear flux path extends between an output surface of the flux concentrating assembly and an input surface of the flux concentrating assembly. The sensor is disposed within the linear flux path and between the output surface and the input surface and in electromagnetic communication with a sensor portion of the magnetic field to monitor multi-directional movement of the selector body.

According to yet another aspect, a selector assembly includes a magnet that is attached to a selector body that is operable within a selector housing, first and second flux concentrators that direct a magnetic field of the magnet through a sensor portion of the magnetic field, and a three-dimensional sensor that is disposed within the sensor portion and is attached to the selector housing. Motion of the selector body moves the sensor portion of the magnetic field relative to the three-dimensional sensor. Further, the three-dimensional sensor detects movement of the sensor portion and communicates the movement of the sensor portion to a controller.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of a selector assembly that incorporates an aspect of a magnet assembly having flux concentrators;

FIG. 2 is a cross-sectional view of the selector assembly of FIG. 1 taken along line II-II;

FIG. 3 is an exploded perspective view of the selector assembly of FIG. 1;

FIG. 4 is a side perspective view of a selector shown positioned with a sensor and a printed circuit board (PCB) disposed in relation to the magnet assembly;

FIG. 5 is a side elevational view of the selector of FIG. 4;

FIG. 6 is a cross-sectional view of the selector of FIG. 5 taken along line VI-VI;

FIG. 7 is a cross-sectional view of the selector of FIG. 4 taken along line VII-VII;

FIG. 8 is a perspective view of a selector body that incorporates an aspect of the flux concentrators;

FIG. 9 is a cross-sectional view of the selector body of FIG. 8 taken along line IX-IX;

FIG. 10 is an exploded perspective view of the selector body of FIG. 8;

FIG. 11 is a perspective view of the magnet assembly that includes a single magnet and the opposing flux concentrators;

FIG. 12 is a schematic elevational view of the magnet assembly of FIG. 10 and showing a sensor portion of the magnetic field for the magnet;

FIG. 13 is an exploded perspective view of the magnet assembly of FIG. 11; and

FIG. 14 is a schematic diagram illustrating the magnetic field of the magnet as directed by the flux concentrators of the magnet assembly in relation to the three-dimensional sensor.

The components in the figures are not necessarily to scale, emphasis being placed upon illustrating the principles described herein.

### DETAILED DESCRIPTION

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

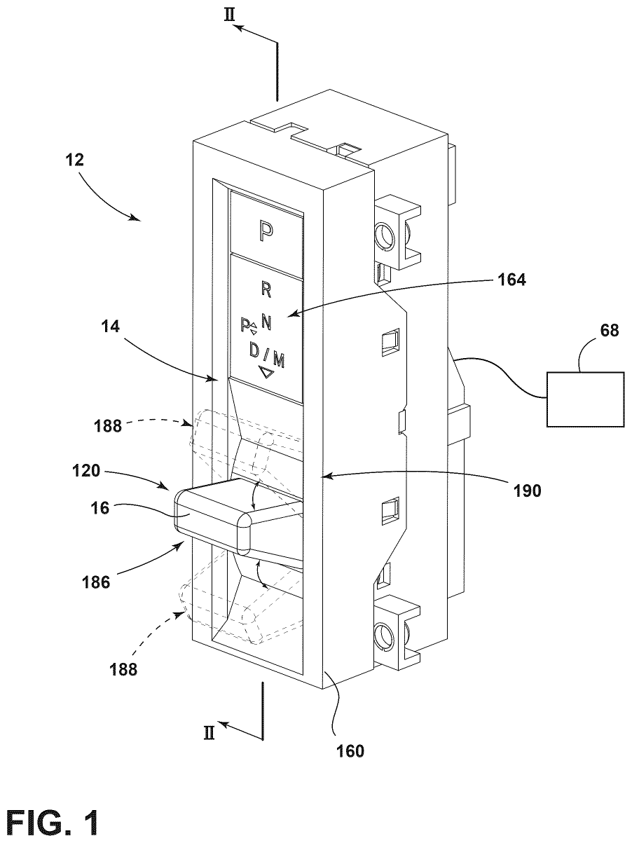

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a magnet assembly for a selector that includes opposing flux concentrators extending from a single magnet. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination. In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

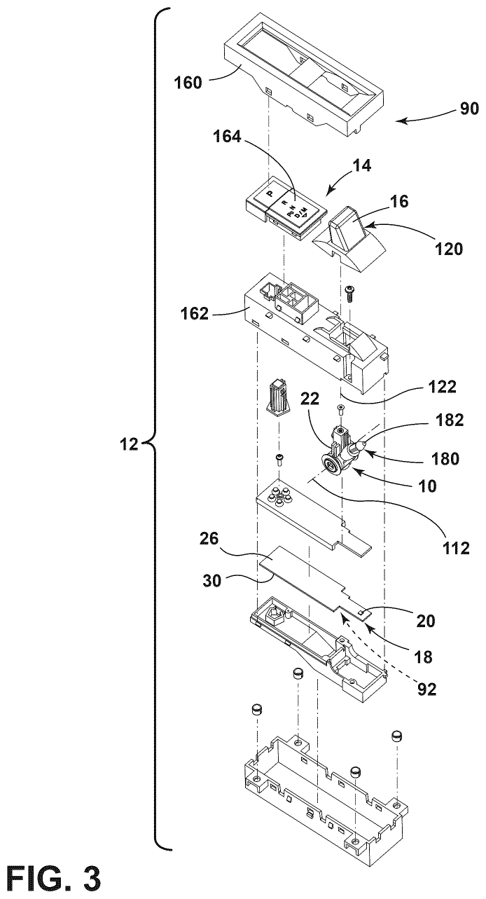

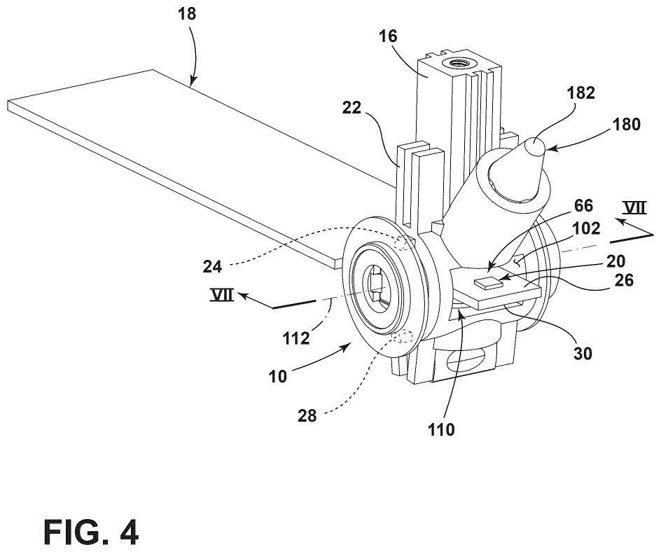

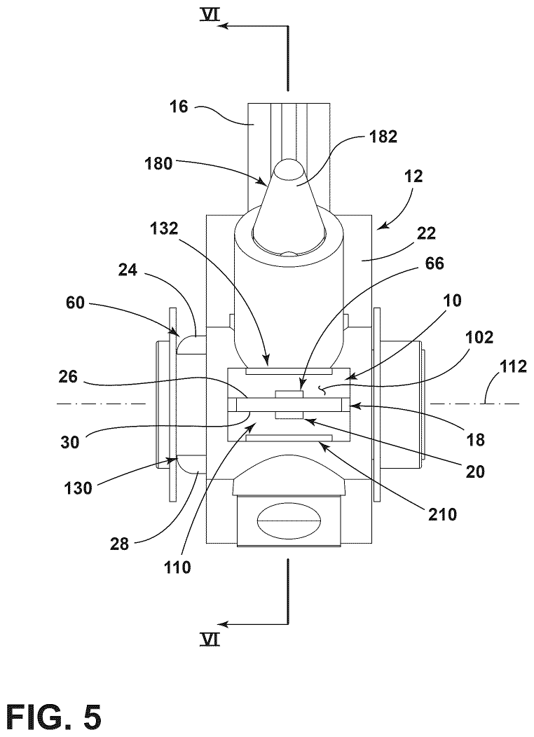

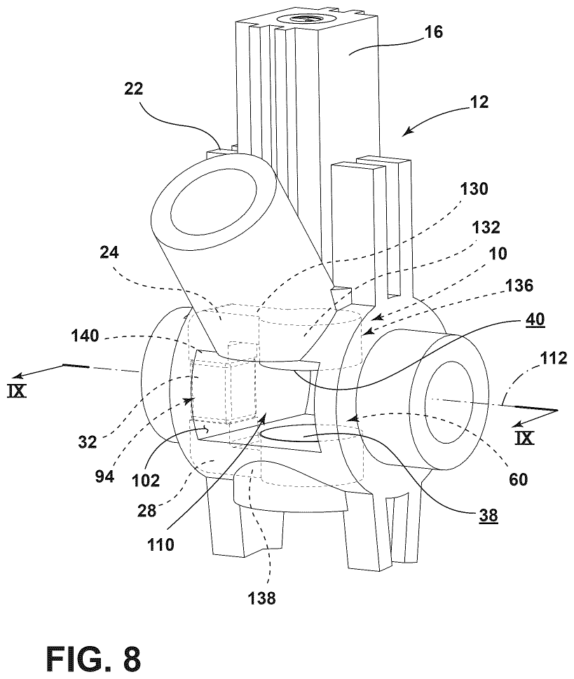

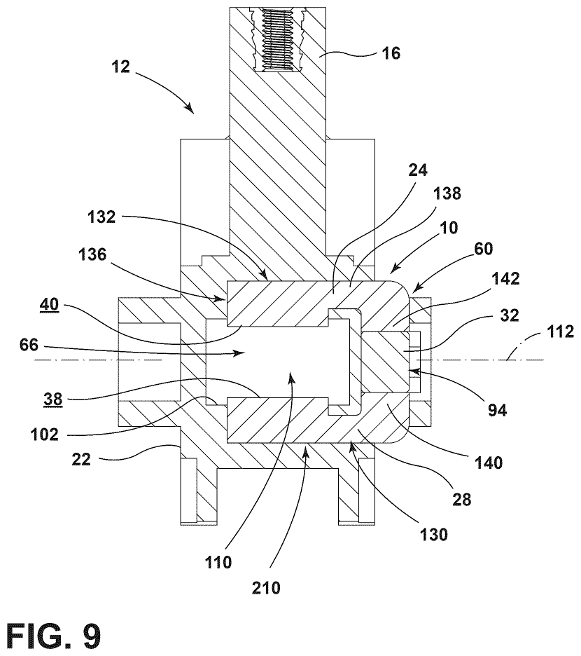

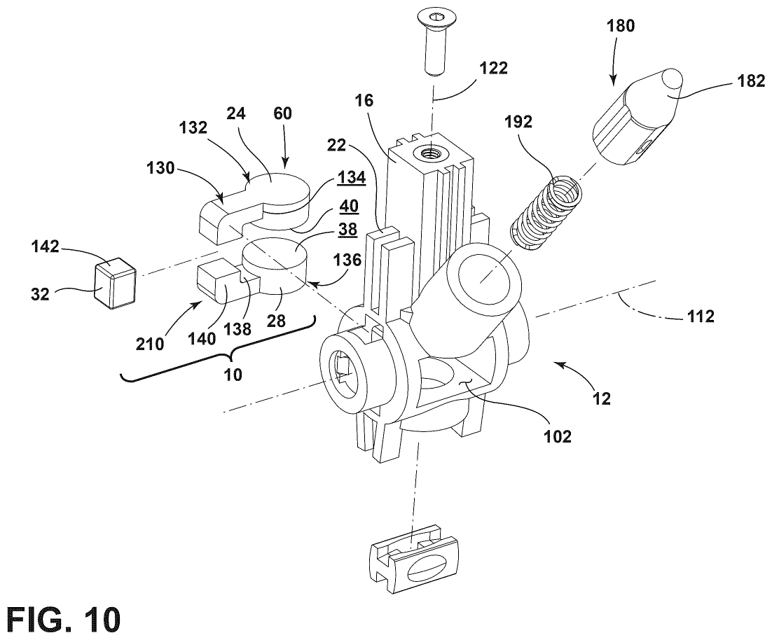

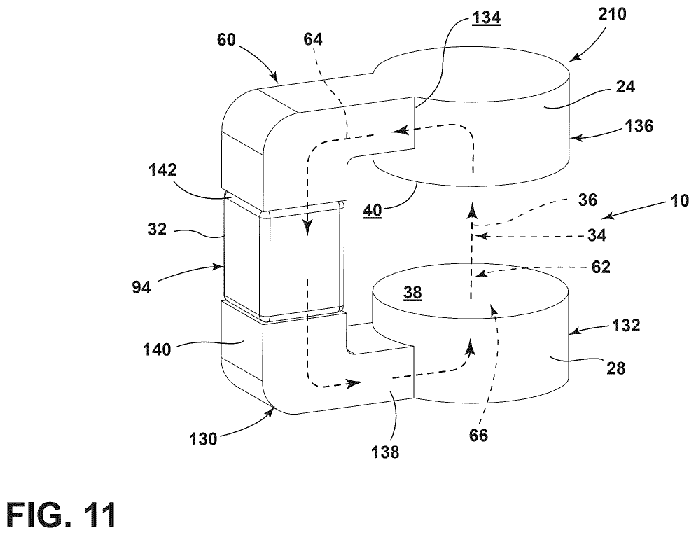

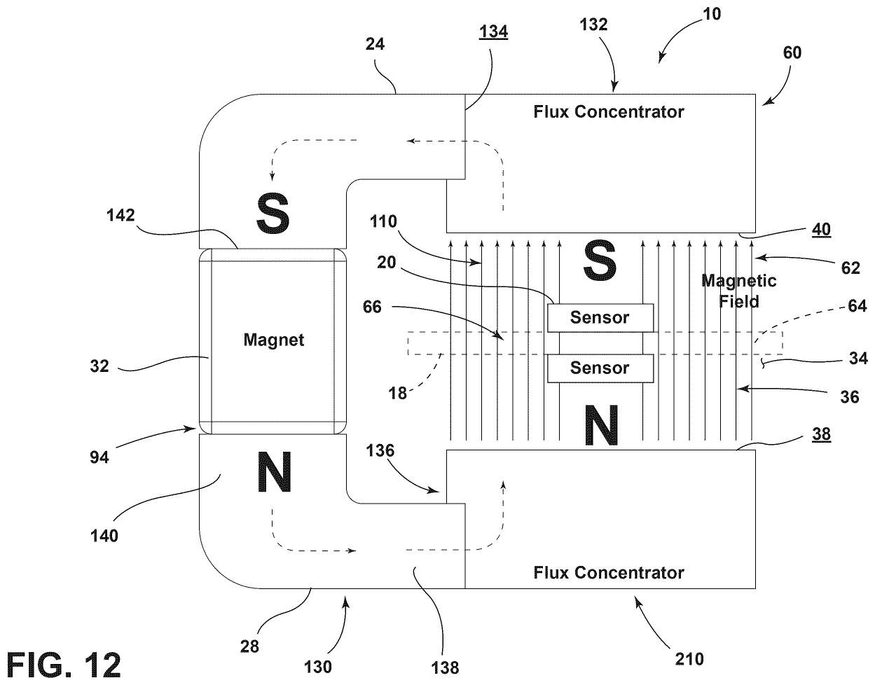

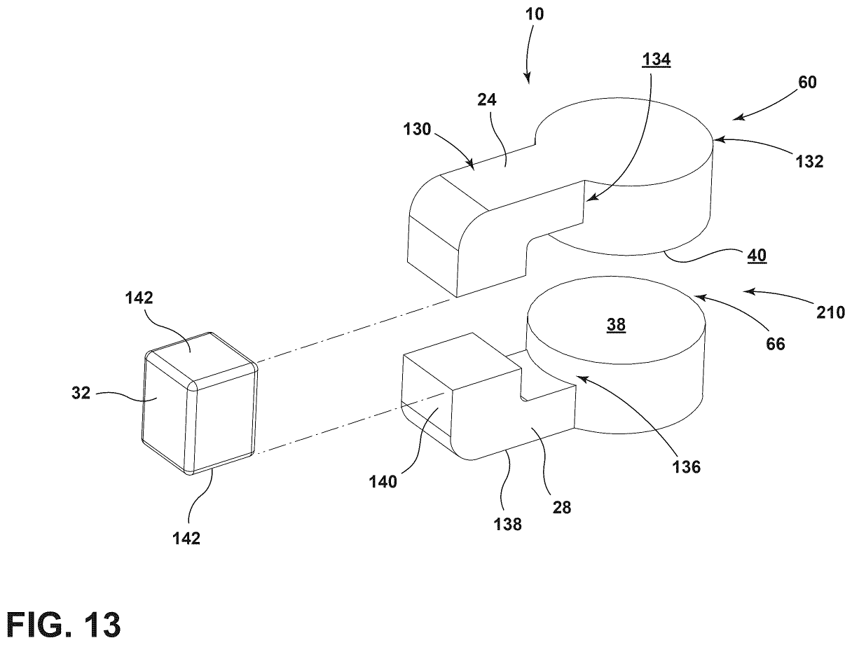

Referring to FIGS. 1-14, reference numeral 10 generally refers to a magnet assembly that is disposed within a selector assembly 12 for a vehicle, appliance, fixture, or other similar application having a user interface 14. According to various aspects of the device, the selector assembly 12 includes a selector 16. A printed circuit board (PCB) 18 having a magnet sensor 20, such as a three-dimensional magnet sensor 20, is included for monitoring multi-directional movement of the selector 16. The magnet assembly 10 is attached to the selector 16. Typically, the magnet assembly 10 is incorporated within a body 22 of the selector 16, and is in electromagnetic communication with the three-dimensional magnet sensor 20. The magnet assembly 10 includes a first flux concentrator 24 that is positioned to a first side 26 of the PCB 18 and the three-dimensional magnet sensor 20. A second flux concentrator 28 of the magnet assembly 10 is positioned to a second side 30 of the PCB 18 and the three-dimensional magnet sensor 20. Typically, the first flux concentrator 24 and the second flux concentrator 28 are positioned to opposite sides of the three-dimensional magnet sensor 20. A magnet 32 is included in the magnet assembly 10 for generating a magnetic field 34 that is sensed by the three-dimensional magnet sensor 20. The magnet 32 is engaged with the first flux concentrator 24 and the second flux concentrator 28. The magnetic field 34 of the magnet 32 is directed through the first and second flux concentrators 24, 28 to create a sensor portion 36 of the magnetic field 34. The sensor portion 36 of the magnetic field 34 is defined by a linear flux path 64 that extends between an output surface 38 of the first flux concentrator 24 and an input surface 40 of the second flux concentrator 28. The sensor portion 36 of the magnetic field 34 extends linearly through the three-dimensional magnet sensor 20.

According to the various aspects of the device, as exemplified in FIGS. 1-14, the magnetic field 34 of the magnet assembly 10 utilizes the first and second flux concentrators 24, 28 for directing the magnetic field 34 of the magnet 32 into a particular orientation as it passes through the three-dimensional magnet sensor 20. The sensor portion 36 of the magnetic field 34 is directed in a generally linear orientation 62. In this manner, the flux paths 64 of the magnetic field 34 are directed in a straight and linear path through the three-dimensional magnet sensor 20 of the PCB 18. Accordingly, the three-dimensional magnet sensor 20 is positioned within a sensing area 66 defined between the first flux concentrator 24 and the second flux concentrator 28. The magnetic field 34 extends through the sensing area 66. Movement of the selector 16, in turn, moves the magnet assembly 10 and the magnetic field 34 relative to the three-dimensional magnet sensor 20. In this manner, the motion of the selector 16 and the magnetic field 34 relative to the three-dimensional magnet sensor 20 is communicated to a controller 92 for operating a mechanical assembly 68.

As described more fully herein, this configuration creates the substantial sensing area 66 between the first and second flux concentrators 24, 28 where the three-dimensional magnet sensor 20 is located. The orientation and dimensional characteristics of the sensing area 66 provides for certain manufacturing tolerances in the position and orientation of the PCB 18, the magnet sensor 20, the first and second flux concentrators 24, 28 and the magnet 32 within the selector assembly 12, without losing resolution of the magnet assembly 10 and the magnetic field 34 with respect to the magnet sensor 20.

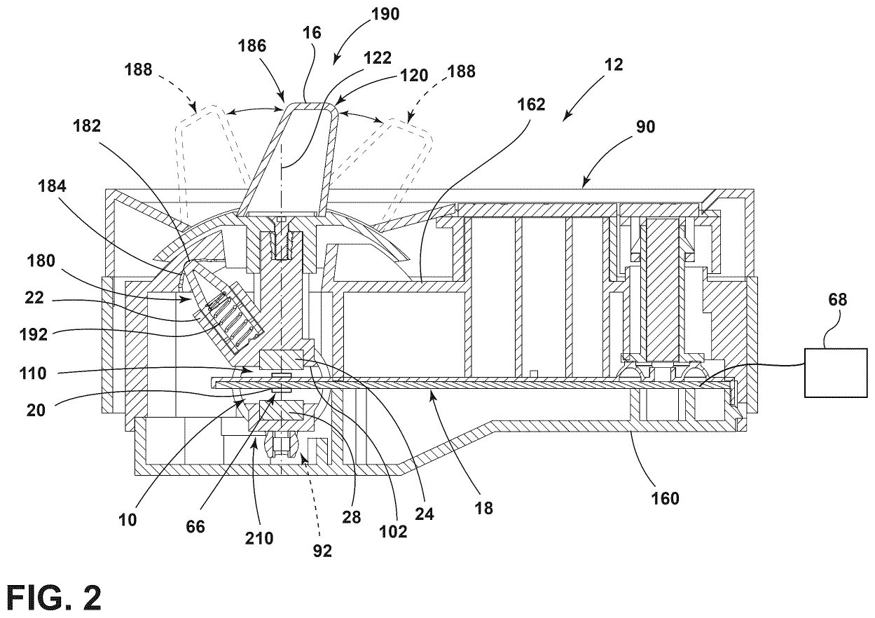

Referring again to FIGS. 2-14, the PCB 18 is attached to a selector housing 90 that at least partially surrounds the body 22 of the selector 16. Accordingly, the PCB 18 and the magnet sensor 20 are in a generally fixed position within the selector housing 90. The selector 16 moves within the selector housing 90 and relative to the PCB 18 and the magnet sensor 20. The body 22 of the selector 16 includes an interior surface 102 that defines a sensor cavity 110 that houses the magnet assembly 10. The magnet assembly 10 is attached to the interior surface 102 of the body 22 to position the magnet assembly 10 relative to the PCB 18 and the magnet sensor 20 and to define the position of the sensing area 66 of the magnet assembly 10.

As described herein, the selector 16 operates relative to the selector housing 90. The selector housing 90 is attached to a panel or other portion of the vehicle or other fixture that includes the user interface 14. The magnet assembly 10 is attached to the body 22 of the selector 16, typically by insert injection molding, adhesives, fasteners, combinations thereof, and other similar attachment methods and mechanisms.

As exemplified in FIGS. 2-14, the body 22 of the selector 16 is operated by a user to make certain selections with respect to the user interface 14. As the body 22 is manipulated by the user, the magnet assembly 10 and, in turn, the magnetic field 34 are operated with respect to the PCB 18 and the three-dimensional magnet sensor 20. Movements of the magnet assembly 10 and the magnetic field 34 are monitored by the three-dimensional magnet sensor 20. This motion of the sensor portion 36 of the magnetic field 34 is sensed and monitored by the three-dimensional magnet sensor 20. The magnet sensor 20 and the PCB 18 monitor these movements and convert these movements of the sensor portion 36 of the magnetic field 34 to corresponding signals that are transferred or otherwise communicated to the controller 92. The controller 92 is coupled with and, in turn, operates a mechanical assembly 68 in communication with the selector assembly 12. As described herein, the mechanical assembly 68 can be in the form of the shift-by-wire mechanism, and other assemblies, for performing a particular operation or set of operations.

Referring again to FIGS. 1-14, at least a portion of the magnet assembly 10 is insert injection molded within the body 22 of the selector 16. In this manner, the first flux concentrator 24 and the second flux concentrator 28 are insert injection molded and form a magnet receptacle 94 between these components. The magnet receptacle 94 can receive the magnet 32 that directs the magnetic field 34 through the first and second flux concentrators 24, 28. In such an aspect of the device, the magnet 32 is inserted into the magnet receptacle 94 and attached to the first flux concentrator 24 and the second flux concentrator 28 via adhesives, welding, combinations thereof, and other similar attachment methods. It is also contemplated that the magnet 32 can be insert injection molded within the selector body 22 along with the first and second flux concentrators 24, 28.

Further, in certain aspects of the device, it is contemplated that the magnet assembly 10, or a portion of the magnet assembly 10, can be attached to the body 22 through various fasteners that can be used to retain the magnet assembly 10 within the body 22 of the selector 16. These various fastening mechanisms and methods can include fasteners, interference mechanisms, combinations thereof, and other similar attachment types.

Referring again to FIGS. 2-14, the space between the output surface 38 of the first flux concentrator 24 and the input surface 40 of the second flux concentrator 28 forms a sensing area 66 of the magnet assembly 10. The three-dimensional magnet sensor 20 is disposed within the sensing area 66. Movements of the body 22 for the selector 16 cause the magnet assembly 10 to operate about at least one rotational axis 112. In this manner, when the magnet assembly 10 and the sensor portion 36 of the magnetic field 34 are moved, the orientation of the sensing area 66 and the magnetic field 34 passing therethrough are also changed. With the sensor portion 36 of the magnetic field 34 extending through the sensing area 66, changes in the orientation of the magnet assembly 10 and the sensor portion 36 of the magnetic field 34 are detected by the three-dimensional magnet sensor 20. The body 22 of the selector 16 can operate according to one or more rotational axes 112. In certain aspects of the device, the body 22 can operate about a single rotational axis 112 relative to the magnet sensor 20 and the PCB 18. It is also contemplated that the body 22 can operate according to other directional paths, such as a universal ball-and-socket, linear paths, axial paths, combinations thereof and other similar operational paths.

The magnet 32 of the selector assembly 12 can be in the form of an NdFeB magnet, other neodymium magnet, other permanent magnet, combinations thereof, and other similar magnetic materials. It is contemplated that the first and second flux concentrators 24, 28 are made of a first material, typically in the form of iron, steel, various ferrous materials, combinations thereof, and other similar materials that can form a flux path 64, or path of least reluctance, through which a magnetic field 34 can be directed for forming the sensor portion 36 of the magnetic field 34. Other ferrous materials can be used for forming the first and second flux concentrators 24, 28.

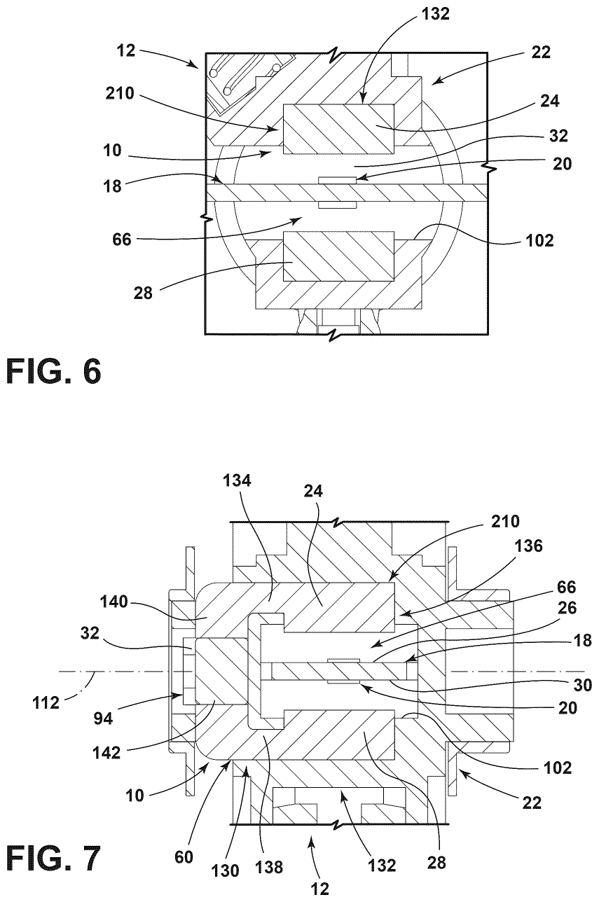

Referring now to FIGS. 6-14, each flux concentrator 60 of the first and second flux concentrators 24, 28 can include a neck portion 130 and a head portion 132. The neck portion 130 extends from the magnet receptacle 94 and engages the head portion 132 of the flux concentrator 60, typically within a side surface 134 of the head portion 132. Through this orientation, the head portion 132 is positioned in an offset configuration 136 with respect to a transverse section 138 of the neck portion 130 for the flux concentrator 60. The neck portion 130 also includes an axial section 140 that extends outward from a polar end 142 of the magnet 32. In this manner, the axial sections 140 of the neck portion 130 extend outward in opposing directions from the polar ends 142 of the magnet 32.

Referring again to FIGS. 6-14, these axial sections 140 assist in providing flux paths 64 for the magnetic field 34 to extend to and through the head portions 132 of the first and second flux concentrators 24, 28, output surface 38 and input surface 40, respectively. Additionally, this offset configuration of the head portions 132 can be utilized for directing the flux paths 64 of the magnetic field 34 through the sensor portion 36. In this manner, the magnetic field 34 extends in a generally linear flux path 64 and through the sensing area 66 to define the sensor portion 36 of the magnetic field 34. By having the output surface 38 of the first flux concentrator 24 and the input surface 40 of the second flux concentrator 28 in the offset configuration, a path of least reluctance is generated where the magnetic field 34 is directed through the linear flux path 64 of the sensor portion 36 for the magnetic field 34. Contemporaneously, the magnetic field 34 within the sensor portion 36 is prevented from deviating away from the sensor portion 36 and toward the neck portion 130 of the first and second flux concentrators 24, 28. As described herein, the configuration of the magnet assembly 10 generates the linear flux path 64 of the sensor portion 36 of the magnetic field 34. In certain aspects of the device, the flux concentrators 60 may include a longer axial section 140, a shorter axial section 140, or an axial section that is incorporated within the transverse section 138.

Referring again to FIGS. 6-14, the shapes of the neck portion 130 and the head portion 132 are illustrated in an exemplary and non-limiting configuration. The shapes and profiles of the flux concentrators 60 can be rounded, polygonal, combinations thereof, as well as other similar configurations. The flux concentrators 60 are configured to direct the magnetic field 34 of the magnet 32 from the magnet 32 and to the sensor portion 36 to create the generally linear orientation 62 of the flux paths 64 of the sensor portion 36.

According to the various aspects of the device, the selector 16 can be in the form of a lever that is operated about at least one rotational axis 112. It is also contemplated that the selector 16 can operate about multiple rotational axes 112 such that fore-aft and side-side movements, and variations therebetween, are provided for by the selector 16. In certain aspects of the device, the selector 16 can also be in the form of a switch, dial, linearly operable mechanism, and other similar user interface devices. Typically, the selector 16 is in the form of a lever, switch, or other similar operable user interface.

As described herein, operation of the selector 16, typically in a rotational configuration, corresponds to motion of the magnet assembly 10 and the sensor portion 36 of the magnetic field 34 relative to the three-dimensional magnet sensor 20. Movements of the sensor portion 36 of the magnetic field 34 are monitored by the three-dimensional magnet sensor 20. These movements correspond to instructions that are delivered by the three-dimensional magnet sensor 20 and to a controller 92 for operating the particular mechanical assembly 68 attached to the selector assembly 12.

It is also contemplated that the selector 16 can include an axial portion 120, such as an axial selection interface. This axial portion 120 can include various interface mechanisms that can include, but are not limited to, a button, a sleeve, a toggle, or other axially operable switch. This axial portion 120 of the selector 16 can operate along a longitudinal axis 122 of the selector 16 relative to the sensor cavity 110. In this manner, the axial portion 120 typically operates in a direction parallel with the longitudinal axis 122 of the selector 16. Manipulation of the axial portion can result in a corresponding axial motion of the magnet assembly 10, or a portion of the magnet assembly 10, with respect to the three-dimensional magnet sensor 20 of the PCB 18. These axial motions of the magnet assembly 10 also result in changes in the sensor portion 36 of the magnetic field 34. Similar to the rotational operation of the selector 16, these axial motions of the selector 16 can also be monitored by the three-dimensional magnet sensor 20 for delivering signals to the controller 92.

In certain aspects of the device, it is contemplated that the magnet assembly 10 can be attached to the selector housing 90 and the magnet sensor 20 can be attached to the selector 16. In such an aspect of the device, operation of the selector 16 moves the magnet sensor 20 within the stationary magnet assembly 10 and the stationary magnetic field 34 of the magnet assembly 10. In this manner, the motion of the magnet sensor 20 within the stationary linear flux path 64 of the magnetic field 34 is communicated to the controller 92.

Referring now to FIGS. 6-7, it is contemplated that the three-dimensional magnet sensor 20 can include a three-dimensional Hall sensor. This three-dimensional Hall sensor, in a non-limiting example, can include a dual die three-dimensional Hall sensor. This dual die three-dimensional Hall sensor can be positioned to one side of the PCB 18. Additionally or alternatively, one or more single die Hall sensors can be positioned on opposing sides of the PCB 18. Working together, these Hall sensors can sense motion of the sensor portion 36 of the magnetic field 34 through three respective axes 112 of rotation, or three separate orientations of motion. Accordingly, it is contemplated that the three-dimensional magnet sensor 20 can include one sensor or a plurality of sensors that interact with the sensor portion 36 of the magnetic field 34. Through this configuration, the one or more Hall sensors can monitor the motion and manipulation of the sensor portion 36 of the magnetic field 34 as the magnet assembly 10 and the selector 16 operate within the selector housing 90 and relative to the PCB 18. Additional Hall sensors can be included in the magnet sensor 20 for monitoring and sensing additional directions of motion of the sensor portion 36 of the magnetic field 34.

According to various aspects of the device, as exemplified in FIGS. 1-3, the selector assembly 12 can include the selector housing 90 having an outer housing 160. Various interior substrates 162 can also be included within the selector housing 90. These substrates 162 can be used for positioning the internal components of the selector assembly 12. By way of example, and not limitation, the body 22 of the selector 16, as well as various components of the controller 92, can be attached to the substrate 162. Various indicia 164 can be attached to portions of the outer housing 160 for providing instruction about operation of the selector 16 for the selector assembly 12.

Referring again to FIGS. 1-10, the selector 16 includes a detent mechanism 180 having a detent pin 182. The detent pin 182 operates in conjunction with a detent surface 184 that is defined by a portion of the selector housing 90. The detent surface 184 is positioned around at least a portion of the body 22 for the selector 16.

In certain aspects of the device, the detent pin 182 and the detent surface 184 define a home position 186 and at least one shift position 188. In certain aspects of the device, the at least one shift position 188 can include two opposing shift positions 188 that are distal from the home position 186. Using these opposing shift positions 188, the selector 16 can be configured to cycle through a plurality of selector positions 190. In such an aspect of the device, the selector 16 can be moved in a forward or aft direction to cycle between various positions of a vehicle transmission, such as reverse, neutral, drive, manual, and other similar gear selections. The cycling of these gear positions can be accomplished by holding down the selector 16 in the shift position 188 or by moving the selector 16 a certain number of times into the shift position 188 to change the selector position 190. In this aspect of the device, the selector 16 can be biased toward the home position 186 by detent spring 192 that extends between the detent pin 182 and the body 22 of the selector 16, the detent pin 182 and detent spring 192 being used to bias the body 22 of the selector 16 toward the home position 186.

In certain aspects of the device, the detent pin 182 and the detent surface 184 can define a plurality of selector positions 190. The detent surface 184 can include certain undulations that receive the detent pin 182 and maintain the position of the selector 16 in these detent positions, which correspond to selector positions 190. As discussed herein, the selector positions 190 can include various vehicle transmission settings. These vehicle transmission settings can include at least reverse, neutral, drive, manual, and other similar vehicle transmission settings. The selector 16 can also be utilized for changing a gear differential between two-wheel drive, four-wheel drive, four-wheel-low drive, and other similar differential settings. In this aspect of the device, the detent pin 182, the detent spring 192, and the detent surface 184 can operate to bias the detent pin 182 and the body 22 for the selector 16 towards the nearest selector position 190.

According to the various aspects of the device, the selector assembly 12 can be utilized within various mechanical assemblies. Such mechanical assemblies can include, but are not limited to, mechanical selector systems, shift-by-wire mechanisms for vehicle transmissions and vehicle differentials, combinations thereof, and other similar mechanical assemblies. Typically, the controller 92 for the selector assembly 12 places the three-dimensional magnet sensor 20 in communication with the mechanical assembly 68. Accordingly, the motion of the magnet assembly 10 and the sensor portion 36 of the magnetic field 34 is communicated from the magnet sensor 20 of the PCB 18 to the mechanical assembly 68 via the controller 92 of the selector assembly 12.

Referring again to FIGS. 1-14, the selector assembly 12 includes the body 22 for the selector 16 that is operably positioned within the selector housing 90. The PCB 18 is attached to the selector housing 90 and includes the magnet sensor 20 for monitoring the multi-directional movement of the body 22 for the selector 16. The magnet 32 is attached to the body 22 for the selector 16 and generates a magnetic field 34. A flux concentrating assembly 210 is attached to the body 22 for the selector 16. The flux concentrating assembly 210, which typically includes the first flux concentrator 24 and the second flux concentrator 28, is attached to the magnet 32 that generates the magnetic field 34. Movement of the body 22 produces a corresponding movement of the magnet 32 and the flux concentrating assembly 210 around the magnet sensor 20 of the PCB 18. The flux concentrating assembly 210 is configured to define a sensor portion 36 of the magnetic field 34. This sensor portion 36 is defined by a linear flux path 64 that extends between the output surface 38 and the input surface 40 of the flux concentrating assembly 210. The magnet sensor 20 is disposed between the output surface 38 and the input surface 40 and is in communication with the sensor portion 36 of the magnetic field 34. As described herein, when the body 22 of the selector 16 is operated, the sensor portion 36 of the magnetic field 34 is manipulated with respect to the magnet sensor 20. The magnet sensor 20 monitors these movements of the sensor portion 36 of the magnetic field 34 and communicates corresponding instructions to the controller 92.

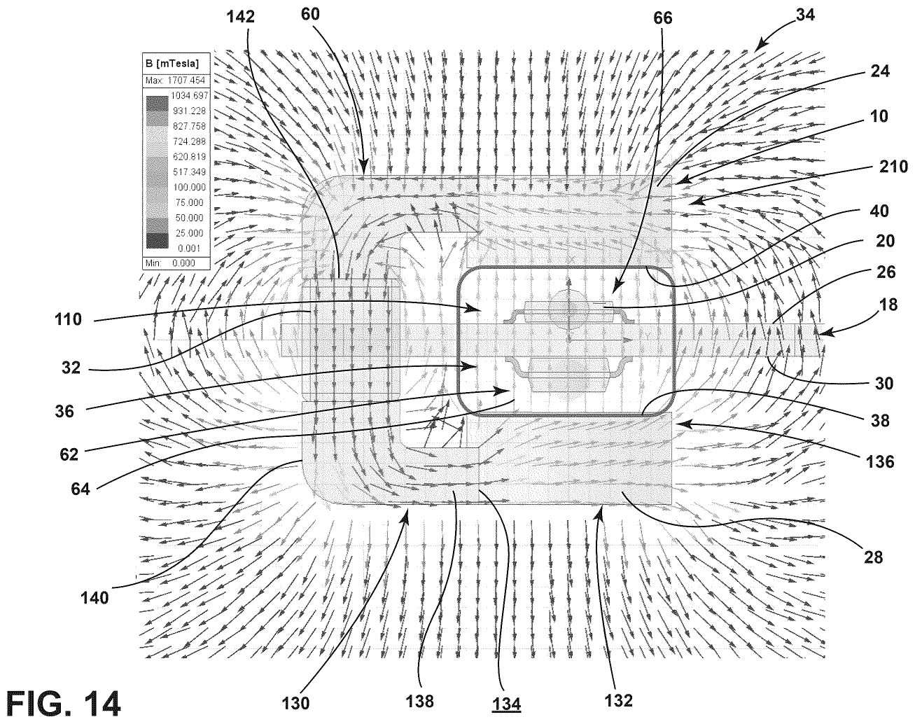

Referring now to FIG. 14, use of the first and second flux concentrators 24, 28 of the magnet assembly 10 operate to direct a magnetic flux of the magnetic field 34 through the neck portion 130 of the first and second flux concentrators 24, 28 and into the head portion 132 of each of the first and second flux concentrators 24, 28. The output surface 38 and the input surface 40 are positioned to direct the linear flux paths 64 therebetween. These linear flux paths 64 are generally in a linear orientation 62 and extend through the three-dimensional magnet sensor 20 in a consistent and linear orientation 62. Through this configuration, manipulation of the body 22 for the selector 16 changes the positioning of the magnet assembly 10 and the sensor portion 36 of the magnetic field 34 relative to the magnet sensor 20. Using this single magnet 32, the opposing first and second flux concentrators 24, 28 can direct the magnetic field 34 in a consistent and linear orientation 62 of the flux paths 64 that extend between the output surface 38 and the input surface 40 of the magnet assembly 10 and through the magnet sensor 20 of the PCB 18.

Studies of the device have shown that this configuration of the magnet assembly 10 that incorporates the first and second flux concentrators 24, 28 and a single magnet 32 can account for various tolerances within the selector assembly 12. Tolerances related to the positioning of the first and second flux concentrators 24, 28 and/or the magnet 32 within the body 22 for the selector 16, as well as tolerances in the positioning of the PCB 18 within the sensing area 66 of the sensor cavity 110 are provided for within this configuration of the selector assembly 12. These tolerances can be within a range of approximately 3 millimeters in deviation in any direction from the designed position or orientation of the components. This deviation can occur within the positioning of the first and second flux concentrators 24, 28, the positioning of the magnet 32, the positioning of the PCB 18, the position of the magnet sensor 20, and other similar components within the selector assembly 12.

By utilizing the magnet assembly 10 described herein, a single magnet 32 can be used in combination with opposing first and second flux concentrators 24, 28 for interacting with a three-dimensional magnet sensor 20 of the PCB 18. This configuration of parts results in a linear and highly oriented magnetic flux between the output surface 38 and the input surface 40 of the first and second flux concentrators 24, 28, respectively. This straight-line flux path 64 extending between the first and second flux concentrators 24, 28 provides for a consistent operation of the selector assembly 12 with respect to magnetic field 34 and the three-dimensional magnet sensor 20. This configuration reduces the sensitivity of the system between the three-dimensional magnet sensor 20 and the magnetic field 34 such that greater tolerances are provided for in the manufacturing and assembly process. Additionally, through this configuration, the north and south poles of the magnet 32 can be shifted to be defined within or near the input surface 40 and output surface 38 of the respective first and second flux concentrators 24, 28 to align the sensor portion 36 for the magnetic field 34. Accordingly, the three-dimensional magnet sensor 20 is better able to interact with the sensor portion 36 of the magnetic field 34 within the sensing area 66.

It will be understood by one having ordinary skill in the art that construction of the described disclosure and other components is not limited to any specific material. Other exemplary embodiments of the disclosure disclosed herein may be formed from a wide variety of materials, unless described otherwise herein.

What is claimed is:

1. A selector assembly comprising:
a selector;
a printed circuit board having a three-dimensional sensor for monitoring multi-directional movement of the selector; and
a magnet assembly that is attached to the selector and in electromagnetic communication with the three-dimensional sensor, the magnet assembly comprising:
a first flux concentrator and a second flux concentrator, wherein a sensing area is defined therebetween; and
a magnet generating a magnetic field, the magnet engaged with the first flux concentrator and the second flux concentrator to direct a linear flux path of the magnetic field through the sensing area, wherein the three-dimensional sensor is positioned within the sensing area with the linear flux path extending therethrough, wherein movement of the selector adjusts the relative position of the magnet assembly and the linear flux path with respect to the three-dimensional sensor, and wherein motion of the linear flux path relative to the three-dimensional sensor is communicated to a controller.

2. The selector assembly of claim 1, wherein the linear flux path extends through an output surface of the first flux concentrator and an input surface of the second flux concentrator, wherein the three-dimensional sensor is positioned between the output surface and the input surface.

3. The selector assembly of claim 1, wherein the controller is coupled with a shift-by-wire mechanism of a vehicle transmission.

4. The selector assembly of claim 1, wherein the selector operates about a single rotational axis relative to the printed circuit board.

5. The selector assembly of claim 1, wherein the three-dimensional sensor includes a plurality of sensors that are positioned within the sensing area and the linear flux path of the magnet assembly.

6. The selector assembly of claim 1, wherein the first flux concentrator and the second flux concentrator are made of a ferrous material.

7. The selector assembly of claim 1, wherein the magnet is an NdFeB magnet.

8. The selector assembly of claim 1, wherein the magnet assembly is attached to the selector.

9. The selector assembly of claim 1, wherein the first flux concentrator and the second flux concentrator are insert injection molded within a body of the selector.

10. The selector assembly of claim 9, wherein the body of the selector includes an interior surface that defines a sensor cavity, and wherein the printed circuit board is attached to an outer housing and the printed circuit board extends into the sensor cavity and positions the three-dimensional sensor within the sensing area of the magnet assembly.

11. A selector assembly comprising:
a selector body operably disposed within a selector housing;
a printed circuit board attached to the selector housing and having a sensor;
a magnet that is attached to the selector body, the magnet generating a magnetic field; and
a flux concentrating assembly that is attached to the selector body and the magnet, the flux concentrating assembly configured to define a linear flux path of the magnetic field, the linear flux path extending between an output surface of the flux concentrating assembly and an input surface of the flux concentrating assembly, the sensor disposed within the linear flux path and between the output surface and the input surface and in electromagnetic communication with a sensor portion of the magnetic field to monitor multi-directional movement of the selector body.

12. The selector assembly of claim 11, wherein the flux concentrating assembly includes a first flux concentrator that defines the output surface and a second flux concentrator that defines the input surface.

13. The selector assembly of claim 12, wherein the first flux concentrator and the second flux concentrator are insert injection molded within the selector body.

14. The selector assembly of claim 11, wherein the selector body includes an interior surface that defines a sensor cavity, and wherein the printed circuit board is attached to an outer housing and the printed circuit board extends into the sensor cavity and positions the sensor within the sensor portion of the magnetic field.

15. The selector assembly of claim 12, wherein the first flux concentrator and the second flux concentrator are made of a ferrous material, and the magnet is an NdFeB magnet.

16. A selector assembly comprising:
a magnet that is attached to a selector body that is operable within a selector housing;
first and second flux concentrators that direct a magnetic field of the magnet through a sensor portion of the magnetic field; and
a three-dimensional sensor that is disposed within the sensor portion and is attached to the selector housing, wherein motion of the selector body moves the sensor portion of the magnetic field relative to the three-dimensional sensor, and wherein the three-dimensional sensor detects movement of the sensor portion and communicates the movement of the sensor portion to a controller.

17. The selector assembly of claim 16, wherein the sensor portion is defined by a linear flux path of the magnetic field of the magnet.

18. The selector assembly of claim 16, wherein the first flux concentrator and the second flux concentrator are insert injection molded within the selector body, and wherein the first flux concentrator and the second flux concentrator are positioned at opposing sides of a sensor cavity.

19. The selector assembly of claim 16, wherein the selector body includes an interior surface that defines a sensor cavity, and wherein a printed circuit board is attached to an outer housing and the printed circuit board extends into the sensor cavity and positions the three-dimensional sensor within the sensor portion of the magnetic field.

20. The selector assembly of claim 16, wherein the three-dimensional sensor includes a plurality of sensors that are positioned within the sensor portion of the magnetic field.
